(19) United States
(12) Patent Application Publication
(10) Pub. No.: US 2014/0236929 A1
(43) Pub. Date: Aug. 21, 2014

(54) Search method and search system in microblog and computer storage medium

(71) Applicant: TENCENT TECHNOLOGY (SHENZHEN) COMPANY LIMITED, (unknown)

(72) Inventor: Yujuan Xie, Shenzhen (CN)

(21) Appl. No.: 14/263,227

(22) Filed: Apr. 28, 2014

Related U.S. Application Data
(63) Continuation of application No. PCT/CN2013/073022, filed on Mar. 21, 2013.

(30) Foreign Application Priority Data
Mar. 26, 2012 (CN) 2012100827509

(51) Int. Cl. G06F 17/30

(52) U.S. Cl. CPC G06F 17/30477
USPC 707/722

(57) ABSTRACT

It is described a search method and a search system in a microblog, and a computer storage medium. The search method in a microblog includes: an inputted keyword is received, and it is searched for a microblog account relative to the keyword; it is determined whether there exists a microblog account of a product in a search result, if yes, microblog accounts of products are sorted and preferentially displayed in the search result; otherwise, it is displayed the microblog account relative to the keyword and microblog information corresponding to the microblog account. With the technical solution described herein, microblog accounts of products are displayed preferentially, the utilization rate of the microblog is thus enhanced.

### CROSS REFERENCE TO RELATED APPLICATIONS

This is a continuation application of International Patent Application No. PCT/CN2013/073022, filed on Mar. 21, 2013, which claims priority to Chinese Patent Application No. 201210082750.9 filed on Mar. 26, 2012, the disclosure of which is incorporated by reference herein in its entirety.

### TECHNICAL FIELD

The present disclosure relates to the microblog application on the internet, and particularly to a method and a system for searching contents in a microblog and a computer storage medium.

### BACKGROUND

It might be known that sponsored search is at present mainly provided in specific search engines. After a keyword is inputted by a user, the search engine firstly searches out published information (for examples, sponsored search Ads) matching the keyword, and then displays the published information and the search results on a search results page according to the bidding for the keyword from each advertiser, quality levels of the published information to be displayed, and the amount of published information allowed to be displayed on the search results page. When the published information in the search results is clicked by the user, a publishing page of the published information will be entered and detailed information of the published information can be seen. Meanwhile, a published information pushing system (for example, an advertising system) records the clicks and makes the charge according to the clicks, so as to achieve the advertising of the published information and make the published information provider profit.

Currently, a microblog user often searches in the microblog application for persons, topics, or the like. After inputting a keyword, the user will see microblog information relative to the keyword, which microblog information may include: a username of a microblog user, the number of users followed by the microblog user, the number of the microblog user's followers, the microblog user's authentication information, the microblog user's location, and the like. In the search results, the user can only see the microblog accounts and microblog information containing the keyword, according to which the user estimates the values of the microblog accounts, and may selectively follow them. The search function in the current microblog is limited to microblog accounts searching and microblog contents searching. In addition, in some microblogs, three microblog accounts with most followers will be displayed, but no more detailed information about the microblog accounts can be seen.

The utilization of the current microblog is insufficient, because the functions of search engines are not sufficiently employed in the search system of the microblog, thus unable to get more profit from the microblog.

### SUMMARY

In view of this, a main object of the present disclosure is to provide a search method and a search system in a microblog and a computer storage medium, in which microblog accounts of products are displayed preferentially, thus enhancing the utilization rate of the microblog.

To this end, the technical solutions of the embodiments of the present disclosure are provided as follows.

According to an embodiment of the present disclosure, it is provided a search method in a microblog, which includes:

an inputted keyword is received, and it is searched for a microblog account relative to the inputted keyword;

it is determined whether there exists a microblog account of a product in a search result;

when it is determined there exists a microblog account of a product in the search result, microblog accounts of products are sorted and preferentially displayed in the search result;

when it is determined there does not exist a microblog account of a product in the search result, it is displayed a microblog account relative to the keyword and microblog information corresponding to the microblog account.

In the above method, the method may further include:

after the microblog accounts of the products are preferentially displayed in the search result,

it is calculated the number of followers of a microblog account of a product according to received following requests.

In the above method, a server may receive the inputted keyword and search for a microblog account relative to the keyword.

In the above method, when there are microblog accounts of multiple products in the search result, the microblog accounts of the multiple products may be sorted and placed at the top of all searched-out microblog accounts; and the search result may be displayed by the server. The search result may include a microblog account relative to the keyword, microblog information and published information corresponding to the microblog account.

In the above method, the microblog information may at least include one or more of:

a username of a microblog, number of microblog accounts followed by the microblog, number of followers of the microblog, authentication information of the microblog, and a location of the microblog.

The published information may at least include one or more of: functions, properties, latest promotions and pictures of a product.

In the above method, the microblog accounts of the multiple products may be sorted according to a bidding result. the bidding result may be determined according to effective Cost Per Mille(eCPM).

A microblog account with a highest eCPM may be positioned at the top of all the microblog accounts of the multiple products, a microblog account with a second highest eCPM may be positioned in a second place of all the microblog accounts of the multiple products, and the rest may be positioned accordingly.

In the above method, the step that it is calculated the number of followers of a microblog account of a product may include:

when receiving one following request from a client device, it is added by one at a server which records the number of followers who follow the microblog account of the product.

According to an embodiment of the present disclosure, it is provided a search system in a microblog, which includes a client device and a server,

wherein the client device is configured to input a keyword and send the keyword to the server, and

wherein the server is configured to:
receive the inputted keyword;
search for a microblog account relative to the inputted keyword;
determine whether there exists a microblog account of a product in a search result;
when it is determined there exists a microblog account of a product in the search result, sort microblog accounts of products, and preferentially display the microblog accounts of the products in the search result; and
when it is determined there does not exist a microblog account of a product in the search result, display a microblog account relative to the keyword and microblog information corresponding to the microblog account.

In the above system, the system may further include a server performing calculation,

wherein the client device may be further configured to send a following request to the server performing calculation,

wherein the server performing calculation may be configured to calculate the number of followers of a microblog account of a product according to received following requests, after the microblog accounts of the products are preferentially displayed in the search result.

According to an embodiment of the present disclosure, it is provided a computer storage medium storing computer-executable instructions thereon for executing the above-mentioned search method in the microblog.

According to the search method and the search system in a microblog and the computer storage medium provided by the embodiments of the present disclosure, an inputted keyword is received, and it is searched for a microblog account relative to the keyword; when it is determined there exists microblog accounts of products in the search result, the microblog accounts of the products are sorted and preferentially displayed in the search result. By employing the sorting in the microblog search, it is possible to charge for the search results according to the sort results, and to charge after an account is followed, thereby getting more profits from the microblog. Furthermore, according to the present disclosure, it is possible to display published information corresponding to a microblog account of a product, so as to present the product to users by using the microblog, the microblog utilization is thereby enhanced and the application range of the microblog is expanded.

### BRIEF DESCRIPTION OF THE DRAWINGS

FIG. 1 is a flowchart illustrating a method for searching contents in a microblog according to an embodiment of the present disclosure;

FIG. 2 is a schematic diagram illustrating an architecture where a method for searching contents in a microblog is applied according to an embodiment of the present disclosure;

FIG. 3 is a schematic diagram illustrating a structure of a system for searching contents in a microblog according to an embodiment of the present disclosure.

### DETAILED DESCRIPTION

The basic idea of the present disclosure is: an inputted keyword is received, and microblog accounts relative to the keyword are searched out; when microblog accounts of products exist in search results, the microblog accounts of products are sorted and preferentially displayed; when no microblog account of any product exists in the search results, microblog accounts relative to the keyword and microblog information corresponding to the microblog accounts are displayed.

The present disclosure hereinafter will be described in more details with reference to embodiments in combination with appended drawings.

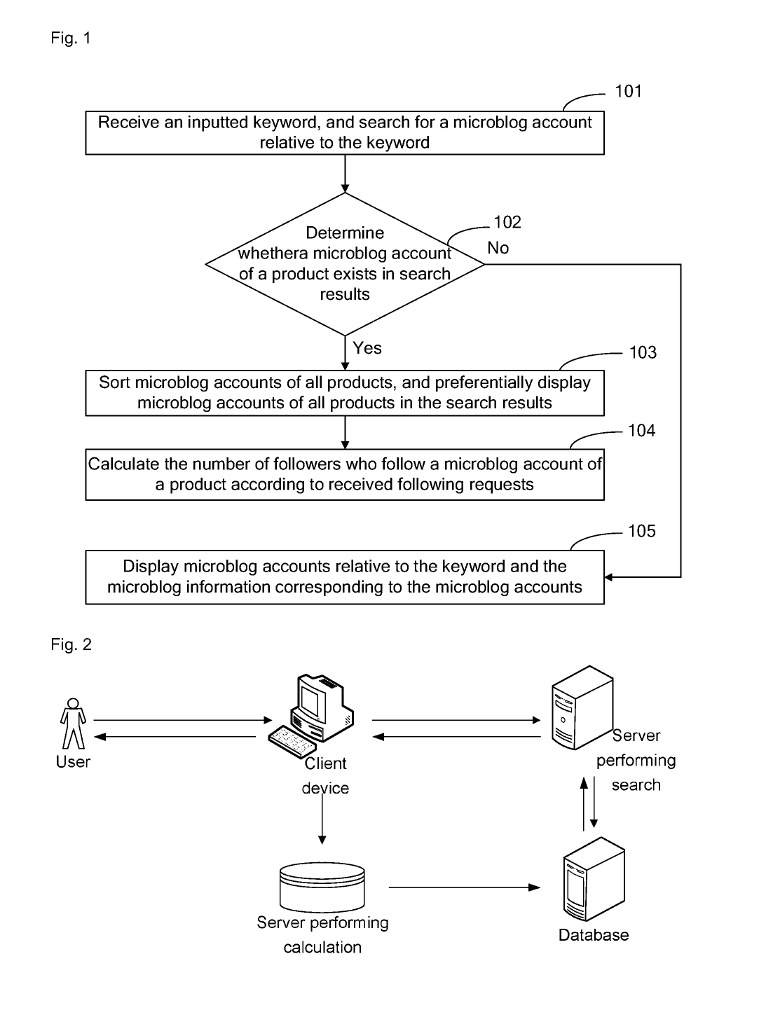

An embodiment of the present disclosure provides a method for searching contents in a microblog. FIG. 1 is a flowchart illustrating a method for searching contents in a microblog according to an embodiment of the present disclosure. Referring to FIGS. 1 and 2, the method includes the following steps.

In Step 101, an inputted keyword is received, and a microblog account relative to the keyword is searched for.

In some examples, a user may input a keyword in a search box of the microblog after logging in the microblog through a client device, and then may click a search button for sending a search request to a server serving the microblog. The server may receive the keyword, and may search a database of the microblog for the microblog accounts relative to the keyword. The client device may be for example a computer, a smart mobile terminal, a tablet computer, or the like, in which a microblog application may be installed.

In Step 102, it is determined whether a microblog account of a product exists in search results, if yes, proceed to Step 103; otherwise, proceed to Step 105.

In some examples, a server may determine whether a microblog account of a product exists among searched-out microblog accounts, if yes, Step 103 is executed; otherwise, Step 105 is executed. In some examples, the product may be referred to an object which is advertised through published information. The product may be for example, electronic products, food products, public welfare activities, or the like.

In Step 103, microblog accounts of all products are sorted and the microblog accounts of all products are preferentially displayed in the search results.

In some examples, if a microblog account of only one product exists in the search results, the sorting is skipped, but the microblog account of the one product is still displayed preferentially in the search results; meanwhile, microblog information and published information corresponding to the microblog account is displayed. In other words, the microblog account of the one product is displayed at the top of all of the searched-out microblog accounts.

In some examples, if there are microblog accounts of a plurality of products in the search results, the microblog accounts of a plurality of products are sorted. In some examples, the microblog accounts may be sorted according to a bidding result. The bidding result may be determined according to the effective Cost Per Mille (eCPM). The microblog account with the highest ePCM is at the top of microblog accounts of all products, and the microblog account with the second highest ePCM is in the second place of microblog accounts of all products, the rest can be deduced accordingly.

After microblog accounts of all products are sorted, the sorted microblog accounts of all products are positioned at the top of all searched-out microblog accounts.

The search results may be displayed by the server, and may include relevant microblog accounts, and microblog information and published information corresponding to the relevant microblog accounts. The microblog information may include: a username of a microblog user, the number of users followed by the microblog user, the number of the microblog user's followers, the microblog user's authentication information, the microblog user's location, and the like. If there exists a microblog account of a product in the search result, then the published information related to the microblog account of the product needs to be displayed. In some examples, the published information may include: functions, properties, latest promotions, pictures of the product, and the like.

In Step 104, it is calculated the number of followers who follow a microblog account of a product, according to received following requests or listening-to requests (tuning-in requests).

After the search results are displayed by the server, a user may browse microblog accounts in the search results via a client device, and may further follow or listen to (tune in) a microblog account of a certain product. When a user follows or listens to (tunes in) a microblog account of a product via the client device, the client device sends a following request or a listening-to (tuning-in) request to a server which records the number of followers who follow the microblog account of the product. Once receiving the following request or listening-to request, the server is added by one. The number of followers recorded by the server may serve as a basis for the next sorting of microblog accounts of products.

When a microblog account of a product post a piece of new microblog information, a user, who follows the microblog account of the product, may see the new microblog information when he/she logs in his/her microblog via a client device, and may forward the published information of the microblog account of the product to a microblog account of his/her friend.

Step 104 is optional for the method for searching contents in the microblog according to the present disclosure. When the method does not include Step 104, the process ends with Step 103. When the method includes Step 104, the process ends with Step 104.

In Step 105, it is displayed microblog accounts relative to the keyword and the microblog information corresponding to the microblog accounts.

In the present disclosure, it is an alternative to only proceed with the process where there is a microblog account of a product in search results, but not proceed with the process where there is no microblog account of any product in the search results.

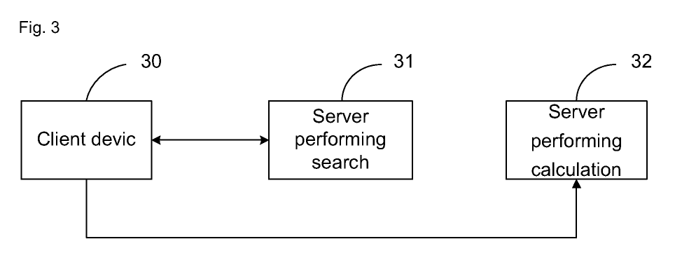

Accordingly, an embodiment of the present disclosure provides a search system in a microblog. Referring to FIG. 3, which is a schematic diagram illustrating a structure of a system for searching contents in a microblog according to an embodiment of the present disclosure, the system includes: a client device 30 and a server 31 performing search.

The client device 30 may be configured to input a keyword and send the keyword to the server 31.

The search server 31 may be configured to:

receive the input keyword;

search for a microblog account relative to the keyword;

determine whether there exists a microblog account of a product in a search result;

when it is determined there exists microblog accounts of products in the search result, sort the microblog accounts of the products, and preferentially display the microblog accounts of the products in the search result; and

when it is determined there does not exist a microblog account of a product in the search result, display a microblog account relative to the keyword and microblog information corresponding to the microblog account.

The system may further include a server 32 performing calculation.

The client device 30 may be further configured to send a following request to the server 32.

The server 32 may be configured to calculate the number of followers of a microblog account of a product according to received following requests, after the microblog accounts of the products are preferentially displayed in the search result.

The search server 31 may, after receiving the inputted keyword, search for a microblog account relative to the keyword in a database of the microblog.

When microblog accounts of multiple products are searched-out, the server 31 may sort the microblog accounts of the multiple products, and may place the sorted microblog accounts of the multiple products at the top of all searched-out microblog accounts, and may display the search result. The search result may include a microblog account relative to the keyword, microblog information and published information corresponding to the microblog account.

The microblog information may at least include one or more of: a username of a microblog, number of microblog accounts followed by the microblog, number of followers of the microblog, authentication information of the microblog, and a location of the microblog.

The published information may at least include one or more of: functions, properties, latest promotions and pictures of a product.

When receiving from a client device one request for following an microblog account of a product, it may be added by one at the server 32 which records the number of followers who follow the microblog account of the product.

When implemented in form of a software functional module and sold or used as an independent product, a server in an embodiment of the present disclosure may be stored in a computer-readable storage medium. Based on such an understanding, the essential part (or a part of the technical solution of an embodiment of the present disclosure contributing to prior art) may appear in form of a software product, which software product is stored in a storage medium, and includes a number of instructions for allowing a computing equipment (such as a personal computer, a server, a network equipment, or the like) to execute all or part of the methods in various embodiments of the present disclosure. The storage media include various media that can store program codes, such as a U disk, a mobile hard disk, a Read-Only Memory (ROM), a Random Access Memory (RAM), a magnetic disk, a CD, and the like. Thus, an embodiment of the present disclosure is not limited to any specific combination of hardware and software.

Accordingly, an embodiment of the present disclosure further provides a computer storage medium in which computer-executable instructions are stored, which computer-executable instructions are for executing the method for searching contents in a microblog according to an embodiment of the present disclosure.

What described are merely preferred embodiments of the disclosure, and are not intended to limit the scope of the present disclosure. Any modification, equivalent replacement, improvement, and the like made within the principle of the present disclosure should be included in the scope of the present disclosure.

1. A search method in a microblog, comprising:
receiving an inputted keyword, and searching for a microblog account relative to the inputted keyword;
determining whether there exists a microblog account of a product in a search result;
when it is determined there exists a microblog account of a product in the search result, sorting microblog accounts of products, and preferentially displaying the microblog accounts of the products in the search result; and
when it is determined there does not exist a microblog account of a product in the search result, displaying the microblog account relative to the keyword and microblog information corresponding to the microblog account.

2. The method according to claim 1, further comprising:
after the preferentially displaying the microblog accounts of the products in the search result,
calculating the number of followers of a microblog account of a product according to received following requests.

3. The method according to claim 1, wherein the receiving an inputted keyword, and searching for a microblog account relative to the keyword comprises:
receiving, by a server serving the microblog, the inputted keyword; and
searching, by the server, a database of the microblog for a microblog account relative to the keyword.

4. The method according to claim 1, wherein the sorting the microblog accounts of the products, and preferentially displaying the microblog accounts of the products in the search result comprises:
when there are microblog accounts of multiple products in the search result, sorting the microblog accounts of the multiple products, and placing the sorted microblog accounts of the multiple products at the top of all searched-out microblog accounts; and
displaying, by the server, the search result, wherein the search result comprises a microblog account relative to the keyword, microblog information and published information corresponding to the microblog account.

5. The method according to claim 4,
wherein the microblog information at least comprises one or more of: a username of a microblog, number of microblog accounts followed by the microblog, number of followers of the microblog, authentication information of the microblog, and a location of the microblog; and
wherein the published information at least comprises one or more of: functions, properties, latest promotions and pictures of a product.

6. The method according to claim 4,
wherein the sorting the microblog accounts of the multiple products comprises: sorting the microblog accounts of the multiple products according to a bidding result;
wherein the bidding result is determined according to effective Cost Per Mille (eCPM); and
wherein the sorting the microblog accounts of the multiple products according to a bidding result comprises: positioning a microblog account with a highest eCPM at the top of all the microblog accounts of the multiple products, positioning a microblog account with a second highest eCPM in a second place of all the microblog accounts of the multiple products, and positioning the rest accordingly.

7. The method according to claim 2, wherein the calculating the number of followers of a microblog account of a product comprises:
when receiving one following request from a client device, adding by one at a server which records the number of followers who follow the microblog account of the product.

8-10. (canceled)

11. A server, being configured to:
receive a keyword from a client device,
search for a microblog account relative to the keyword;
determine whether there exists a microblog account of a product in a search result;
when it is determined there exists a microblog account of a product in the search result, sort microblog accounts of products, and preferentially display the microblog accounts of the products in the search result; and
when it is determined there does not exist a microblog account of a product in the search result, display the microblog account relative to the keyword and microblog information corresponding to the microblog account.

12. The server according to claim 11, being further configured to:
after the preferentially displaying the microblog accounts of the products in the search result,
calculate the number of followers of a microblog account of a product according to received following requests.

13. The server according to claim 11, wherein the sorted microblog accounts of the products are placed at the top of all searched-out microblog accounts.

14. A non-transitory computer-readable storage medium storing instructions thereon for execution by at least one processing circuit, the instructions comprising:
receiving an inputted keyword, and searching for a microblog account relative to the inputted keyword;
determining whether there exists a microblog account of a product in a search result;
when it is determined there exists a microblog account of a product in the search result, sorting microblog accounts of products, and preferentially displaying the microblog accounts of the products in the search result; and
when it is determined there does not exist a microblog account of a product in the search result, displaying the microblog account relative to the keyword and microblog information corresponding to the microblog account.

15. The non-transitory computer-readable storage medium according to claim 14, wherein the instructions further comprise:
after the preferentially displaying the microblog accounts of the products in the search result,
calculating the number of followers of a microblog account of a product according to received following requests.

16. The non-transitory computer-readable storage medium according to claim 14, wherein the receiving an inputted keyword, and searching for a microblog account relative to the keyword comprises:
receiving, by a server serving the microblog, the inputted keyword; and
searching, by the server, a database of the microblog for a microblog account relative to the keyword.

17. The non-transitory computer-readable storage medium according to claim 14, wherein the sorting the microblog accounts of the products, and preferentially displaying the microblog accounts of the products in the search result comprises:
when there are microblog accounts of multiple products in the search result, sorting the microblog accounts of the multiple products, and placing the sorted microblog accounts of the multiple products at the top of all searched-out microblog accounts; and
displaying, by the server, the search result, wherein the search result comprises a microblog account relative to the keyword, microblog information and published information corresponding to the microblog account.

18. The non-transitory computer-readable storage medium according to claim 17, wherein the microblog information at least comprises one or more of: a username of a microblog, number of microblog accounts followed by the microblog, number of followers of the microblog, authentication information of the microblog, and a location of the microblog; and
wherein the published information at least comprises one or more of: functions, properties, latest promotions and pictures of a product.

19. The non-transitory computer-readable storage medium according to claim 17, wherein the sorting the microblog accounts of the multiple products comprises: sorting the microblog accounts of the multiple products according to a bidding result;
wherein the bidding result is determined according to effective Cost Per Mille (eCPM); and
wherein the sorting the microblog accounts of the multiple products according to a bidding result comprises: positioning a microblog account with a highest eCPM at the top of all the microblog accounts of the multiple products, positioning a microblog account with a second highest eCPM in a second place of all the microblog accounts of the multiple products, and positioning the rest accordingly.

20. The non-transitory computer-readable storage medium according to claim 15, wherein the calculating the number of followers of a microblog account of a product comprises:
when receiving one following request from a client device, adding by one at a server which records the number of followers who follow the microblog account of the product.
